(19) United States
(12) Patent Application Publication
(10) Pub. No.: US 2006/0246175 A1
(43) Pub. Date: Nov. 2, 2006

(54) Shaped chewing gum products and methods of making same

(75) Inventor: Angel Palomes Royo, Barcelona (ES)

Correspondence Address: WRIGLEY & DREYFUS 28455;BRINKS HOFER GILSON & LIONE, P.O. BOX 10395, CHICAGO, IL, 60610, US

(73) Assignee: Wm. Wrigley Jr. Company

(21) Appl. No.: 11/413,038

(22) Filed: Apr. 26, 2006

Related U.S. Application Data
(60) Provisional application No. 60/676,573, filed on Apr. 29, 2005.

(51) Int. Cl. A23G 4/18

(52) U.S. Cl. 426/5

(57) ABSTRACT

Shaped chewing gum products are made by mixing guru base, amorphous bulk sweetener and crystalline bulk sweetener together to form a fluid composition and molding that composition into desired shapes. The molding may be accomplished by making multiple depressions in a bed of powder material, each depression having a desired shape; depositing the fluid composition into the depressions at a temperature at which the fluid composition will fill into the shapes of the depressions; allowing the fluid composition to set up to a consistency wherein the composition maintains the shape of the depression to form the shaped chewing gum products; and separating the shaped chewing gum products from the powder material. The chewing gum composition may be combined with another confectionery material to make a composite product.

### RELATED APPLICATION

The present application claims the benefit under 35 U.S.C. § 119(e) of Provisional U.S. Patent Application Ser. No. 60/676,573, filed Apr. 29, 2005; which is hereby incorporated by reference in its entirety.

### BACKGROUND OF THE INVENTION

The present invention relates to chewing gum products and methods of making chewing gum products. Specifically, the present invention relates to chewing gum compositions that can be shaped in a mold, such as by being deposited, to provide intricate shapes, and the methods of making the compositions and products made using the compositions.

Chewing gum is most typically found in rather plain shaped products, such as flat sticks, tabs, chunks, cylinders or pellets. Chewing gum compositions are typically rolled into sheets and scored into sticks, or extruded into ropes and cut into chunks before being wrapped, or pressed into pellets and coated. However, none of these processes allow the chewing gum product to be made into more complicated and interesting shapes.

Another way of making chewing gum products is to use stamping technology. This allows for more interesting shapes, but has a number of drawbacks. First, the mold cavity in which the product is formed cannot have too deep of relief or the product cannot be easily removed from the mold without having its shape distorted. More importantly, the mold tooling is fairly expensive, and hence not easy to change. Thus, it has not been worthwhile to make chewing gum products into a shape for specific holidays, which would need to be changed after just a few weeks of production. Also, if a multi-colored product is desired, it becomes very difficult to make such a product consistently with stamping technology.

Many confectioneries are made in interesting and intricate shapes using depositing. In one example of this process, a bed of powdered material, such as starch, has a depression made in it by a positive of the desired shape. The depression formed in the powder material is a negative of the shape. Liquid confectionery material is deposited in the depression, and then solidifies to the point that the powder material can be removed, leaving the shape in the positive image of the depression. The powder material is reused. If a new shape is desired, the mold face can be changed. However, because one mold face can be used to make literally millions of depressions, the number of mold faces that need to be changed is relatively few, and the mold faces can be made of a material that is inexpensive and easy to shape in the first place, such as plaster, because the mold does not have to withstand the pressures induced in stamping technology.

Heretofore, there has not been a chewing gum composition used to make a deposited, shaped product that has had wide spread commercial acceptance. By its very nature, chewing gum must include an elastomer and other water-insoluble gum base ingredients. The gum base is typically mixed with powdered sugar and other ingredients, such as corn syrup, to make the chewing gum composition. However, even when the gum base is melted and mixed with the other ingredients, the typical chewing gum composition has such a high viscosity that it cannot be poured as a fluid and deposited into a mold. Sugarless chewing gum formulations are also known, but have basically the same consistency as sugar-containing formulations. Of course, modifications to the chewing gum composition can be made to make it more fluid. However, compositional changes that result in a product which is not acceptable from a texture, chew and flavor delivery standpoint will not find acceptance in the marketplace. As a result, it has not been commercially viable to make chewing gum products using a deposition process, and therefore it has not been commercially viable to make intricately shaped chewing gum products, especially products with more than one color layer.

Hence, there is a need for chewing gum products, particularly bubble gum, with intricate shapes that still have the texture and chew characteristics of chewing gum, and compositions and methods that can be used to make chewing gum products with intricate shapes.

### SUMMARY OF THE INVENTION

The present invention provides compositions for, and methods of making, chewing gum products that can be made by a deposition process, and hence that can be made with intricate shapes in a commercially viable manner.

In a first aspect, the invention is a method of making a deposited chewing gum product comprising making bulk sweetener syrup, gum base and powdered bulk sweetener together to form a fluid composition; depositing the fluid composition into a depression made into a bed of powdered material at a temperature at which the fluid composition will fill into at least a portion of the shape of the depression; allowing the fluid composition to set up to a consistency at which the composition maintains the shape of the at least portion of the depression to form the deposited chewing gum product, the set up composition comprising between about 10% and about 60% crystalline bulk sweetener and between about 10% and about 70% amorphous bulk sweetener, preferably between about 40% and about 70% amorphous sugar; and separating the deposited chewing gum product from the powder material.

In a second aspect, the invention is a method of making a shaped chewing gum product comprising mixing a first bulk sweetener syrup and a dry bulk sweetener together and cooking the mixture to adjust the moisture level in the mixture to form a second bulk sweetener syrup; mixing the second bulk sweetener syrup, gum base and powdered bulk sweetener together at a temperature of at least 70° C. to form a heated, fluid composition; introducing the heated composition into a cavity having a desired shape so as to fill into at least a portion of the shape of the cavity; cooling the heated composition to a temperature at which the composition maintains the shape of the at least portion of the cavity to form the shaped chewing gum product; and separating the shaped chewing gum product from the cavity.

In a third aspect, the invention is a multi-layer shaped chewing gum product comprising a first layer comprising a first cooled mixture of bulk sweetener syrup, powdered bulk sweetener and gum base previously heated and mixed into a first homogeneous composition, the first homogeneous composition comprising between about 10% and about 60% crystalline bulk sweetener and between about 10% and about 70% amorphous bulk sweetener, preferably between about 40% and about 70% amorphous sugar; and at least a second layer comprising a second cooled mixture of bulk sweetener syrup, powdered bulk sweetener and gum base previously heated and mixed into a second homogeneous composition different from the first composition; the first and second layers being adhered together forming the product, and the product having an intricate shape.

In a fourth aspect, the invention is a chewing gum composition capable of being deposited to form chewing gum products having intricate shapes, the composition comprising about 12% to about 35% gum base; about 10% to about 80% bulk sweetener syrup; and about 10% to about 78% powdered bulk sweetener, wherein the composition contains less than 10% moisture, has a ratio of crystalline bulk sweetener to amorphous bulk sweetener in said composition of between about 1:14 and about 7:1 crystalline bulk sweetener; amorphous bulk sweetener, and has a viscosity of less than 20 Pa-sec at a temperature of 90° C.

In a fifth aspect, the invention is a shaped chewing gum product comprising a homogeneous composition comprising about 12% to about 30% gum base; about 30% to about 80% of a bulk sweetener syrup comprising about 70% to about 95% of one or more bulk sweeteners and about 5% to about 20% water; and about 10% to about 40% powdered bulk sweetener; wherein the composition has a ratio of crystalline bulk sweetener to amorphous bulk sweetener in said composition of between about 1:14 and about 7:1 crystalline bulk sweetener: amorphous bulk sweetener, and wherein the product is formed into an intricate shape.

It has been discovered that by using a combination of amorphous and crystalline bulk sweeteners at a proper ratio, and by taking a portion of the powdered bulk sweetener used in the composition and cooking it with the bulk sweetener syrup, and using a gum base with correct properties, the viscosity of the chewing gum composition will remain sufficiently low so that the composition can be deposited into molds or depressions made in a bed of starch and thereby produce chewing gum products having intricate shapes. On the other hand, the resulting products form a bolus when consumed that has the same chew characteristics as conventional chewing gum, and in particular conventional bubble gum.

These and other advantages of the invention, as well as the invention itself, will be more easily understood in view of the attached drawings.

### BRIEF DESCRIPTION OF DRAWINGS

FIG. 1 is a perspective view of a first embodiment of the present invention showing a two-layer deposited chewing gum product.

FIG. 2 is a perspective view of a second embodiment of the present invention showing a second two-layer deposited chewing gum product,

FIG. 3 is a perspective view of a third embodiment of the present invention showing a third two-layer deposited chewing gum product.

FIG. 4 is a cross-sectional view of a mold used to make the product of FIG. 3.

FIG. 5 is a cross-sectional view of the mold of FIG. 4 having a first layer of chewing gum product deposited therein.

FIG. 6 is a cross-sectional view of the mold of FIG. 4 having a both the first and second layers of chewing gum product deposited therein.

### DETAILED DESCRIPTION OF THE DRAWINGS AND PREFERRED EMBODIMENTS

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous. The term “chewing gum” as used herein also includes bubble gum and the like. The term “bulk sweetener” as used herein refers to sugars, sugar alcohols and other bulk sweeteners, and combinations thereof, which are typically used for sweetening and/or bulking properties in confectioneries. As used herein, the term “amorphous” refers to the non-crystalline physical solid state of the bulk sweetener. Bulk sweeteners typically form a crystalline state as a solid, but under special conditions may be in an amorphous, or non-crystalline solid state. While amorphous (and even crystalline) bulk sweeteners may contain small amounts of water, the term “amorphous bulk sweeteners” does not include dissolved or melted bulk sweeteners. Unless otherwise indicated, all percentages are given in weight percent.

“Intricate shape“as used herein and in the claims means a shape of a chewing gum product in which the surface is not plain, but rather has one or more of the following attributes: a) concavities; b) compound curves that do not define product edges; c) convex surfaces having acute angles or small radii (less than one third the dimension of the gross piece size) that do not define product edges; d) one or more curved regions having variable radii; and e) product edges that are irregular or not substantially defined by simple geometric shapes.

Of course, the product of the present invention can be made into shapes that are not intricate. For example, any shape that can be made in a bed of starch, such as the shapes of various gummy confectionaries, can be used for the shapes of the products of the present invention.

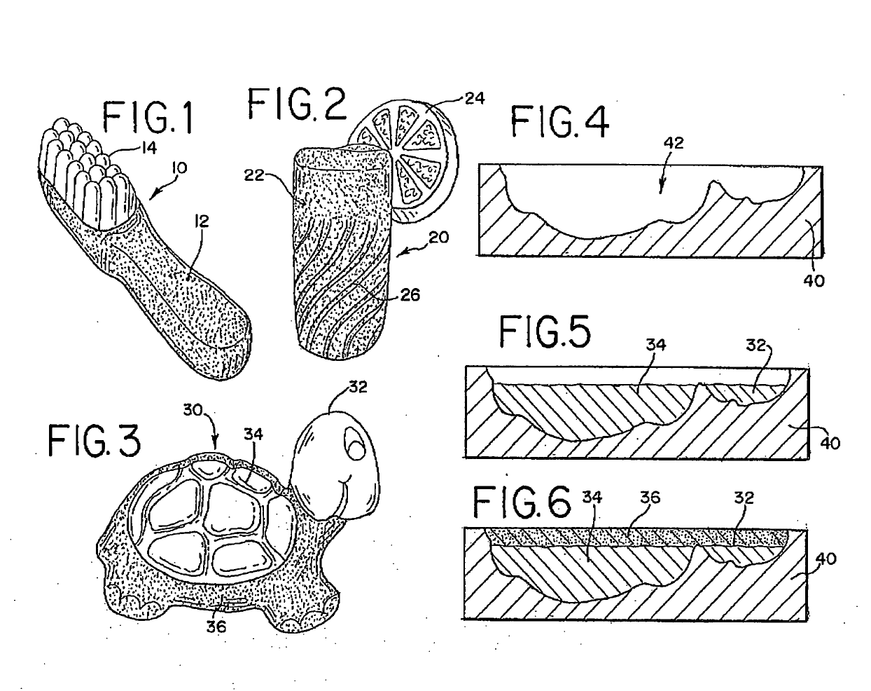

FIGS. 1-3 show perspective views of embodiments of chewing gum products of the present invention. Of course, many other product shapes are also within the scope of the invention. In particular, shapes suitable for specific holidays, such as Jack o'lanterns, ghosts, vampire teeth and skeletons for Halloween, leprechauns for St. Patrick's day, etc., are especially suitable for the present invention.

FIG. 1 shows a toothbrush shaped chewing gum product 10. In the represented example, the handle 12 of the toothbrush and the bristle portion 14 may be made out of separate layers, preferably of different colors, of chewing gum composition. For example, the handle 12 may be brown, and the bristle portion 14 white. The detail that is shown in the bristle portion 14 of FIG. 1 is a good example of the intricate shape that is possible with the present invention. Of course individual bristles will not be identifiable, but as shown the tufts of the bristle portion are clearly discernable. In this embodiment, the bristle portion is made by depositing a white chewing gum composition into the portion of the mold shape forming the bristles 14 and a brown chewing gum composition is poured on top of the first white material and into the portion of the depression that forms the handle 12.

FIG. 2 shows a second chewing gum product 20 in the shape of a drinking glass 22 with a slice of a lemon 24 on the edge of the glass 22. Intricate patterns 26 can be formed in the surface of the drinking glass 20, and the slice of lemon 24 can be molded such that the sections of the lemon are clearly discernable. Further, in this embodiment the lemon slice 24 can be molded from a yellow colored chewing gum composition, while the rest of the product, depicting the drinking glass 22, is made from a contrasting color of chewing gum composition, such as dark green. In this embodiment, if desired, different flavors can be included in the different colored compositions, so that the yellow lemon slice 24 is lemon flavored, and the green drinking glass 22 is time flavored. In this embodiment the green chewing gum composition is deposited first, filing almost the entire depression, and then the yellow composition is deposited in on the top corner of the drinking glass 22 and flows over into the portion of the depression that is used to form the lemon slice 24.

FIG. 3 shows a turtle shaped chewing gum product 30. As with the other products, the turtle product 30 is an intricate shape, with the individual sections of the shell and facial features being distinctly visible. FIGS. 4-6 show the cross section of a mold used in the process by which the turtle product 30 is formed. A bed of starch material 40 has a depression made in it which is a positive (not shown) of the shape of the turtle. The cavity or depression 42 remains after removal of the positive from the bed of starch 40. A first chewing gum composition of the present invention is then deposited in the lower portion of the depression 42, as shown in FIG. 5. In this design, the head 32 and shell 34 of the turtle are both made of the same material, which may be a yellow color for instance. Of course, since the part of the depression forming the head 32 is separated from the portion forming the shell 34, two different compositions, having different colors, could be deposited in these two portions of the depression 42. After this first layer is deposited, as second layer 36 is deposited, covering over the exposed back portions of the head 32 and shell 34, and forming the body, feet and neck of the turtle product 30. In this instance, these portions may be a light green in color. Different flavors may or may not be used in the different portions. The second layer may be deposited while the first layer is still fluid, or it may be deposited after the first layer has already started to solidify. After both layers have cooled, the starch bed 40 is dumped into a sifter that separates the powdered starch material from the product 30. The starch material can then be reused, and the product 30 can be de-dusted or otherwise prepared for packaging and sale.

It was discovered that even with a chewing gum base with a low viscosity was used, when a lot of powdered sugar was added to the composition, the mass lost fluidity and behaved more like a viscoelastic product, and with a viscosity that is highly dependent on shear rate. It was discovered that if the process was modified so that a portion of the powdered sugar was mixed into the corn syrup, which was cooked to reduce its moisture content, a composition was produced that could be deposited. The product made with this concentrated syrup had good processing abilities and textural characteristics.

A method of making deposited chewing gum products according to the present invention generally has the following steps. First, a bulk sweetener and a gum base are mixed to-ether to form a fluid composition. The fluid composition may be formed from a bulk sweetener syrup, gum base and powdered bulk sweetener mixed together at a temperature of at least 70° C., more preferably at least 80° C., and more preferably at least 90° C., to form a heated composition. Meanwhile, at least one depression is made in a bed of powder material. The depression has a desired shape. After the composition is heated, or is otherwise fluid, it is deposited into the depression at a temperature at which the composition will fill into at least a portion of the shape of the depression. As noted above, this composition may be deposited in just the lower section of the mold if a multi-layer product is to be formed. Next the fluid composition is allowed to set up, such as by cooling, to a consistency at which the composition maintains the shape of the at least portion of the depression to form the deposited chewing gum product. Finally, the deposited chewing gum product is separated from the powder material.

The gum base may be a low viscosity regular chewing gum base, or may preferably comprise a low viscosity bubble gum base. The heated composition comprises about 12% to about 35% gum base, more preferably about 12% to about 30% gum base. The gum base preferably has a ring and ball softening point below 70° C., more preferably below 60° C., measured according to ASTM E28-92. The preferred gum base has a viscosity at 100° C. below 5,000 centipoise, more preferably below 3,000 centipoise; measured by a Haake PK100 rotational viscometer (cone&plate), with a PK-I 1° sensor. A preferred gum base is SHAPE gum base, available from CAFOSA GUM, S. A, Calabria, 267, 08029 Barcelona, Spain.

The bulk sweetener syrup may comprise one or more sugars, or comprise one or more polyols for sugarless formulas. If it comprises sugars, the sugars may be selected from the group consisting of fructose, corn syrup, corn syrup solids (sometimes referred to as glucose syrup solids), sucrose, starch hydrolysates, maltodextrins, maltose, dextrin, invert sugar, levulose, galactose, and the like, alone or in combination. If the bulk sweetener syrup is sugarless, it may comprise sugar alcohols selected from the group consisting of sorbitol, maltitol, xylitol, erythritol, lactitol, hydrogenated starch hydrolysates, hydrogenated isomaltulose (also known as isomalt), mannitol, and mixtures thereof. Likewise, if the product is a sugar product, the powdered bulk sweetener may be selected from the group consisting of fructose, sucrose, starch hydrolysates (such as corn syrup solids), maltodextrins and mixtures thereof and if it is sugarless, the powdered bulk sweetener may comprise a sugar alcohol selected from the group consisting of sorbitol, maltitol, xylitol, erythritol, lactitol, hydrogenated starch hydrolysates, hydrogenated isomaltulose, mannitol, and mixtures thereof.

The heated composition may comprise about 10% to about 80% bulk sweetener syrup. The bulk sweetener syrup often comprises between about 30% and about 80% of the heated composition. The heated composition may comprise about 10% to about 80% powdered bulk sweetener.

The heated composition may be made with about 30% to about 80% of a bulk sweetener syrup, comprising about 55% to about 85% of one or more bulk sweeteners and about 5% to about 20% water; and about 10% to about 40% dry (either powdered or granular) bulk sweetener. In an embodiment, a first bulk sweetener syrup and a dry bulk sweetener are mixed together and cooked to reduce the moisture level in the mixture to form a second bulk sweetener syrup. This second bulk sweetener syrup is then mixed with the gum base and powdered bulk sweetener to form the heated composition. A corn syrup may have sucrose added to it and its moisture content reduced by cooking prior to being mixed with the gum base and an additional amount of powdered sucrose. The second bulk sweetener syrup may contain, on a dry basis, about 30% to about 70% sucrose and about 70% to about 30% corn syrup solids; and about 5% to about 20% water in the syrup before the water content is adjusted. The first bulk sweetener syrup and powdered bulk sweetener mixture may be cooked to a temperature of over 120° C., and to a moisture content of less than 15%, more preferably between about 4% and about 10%. More preferably, this second syrup contains about 48.4% sucrose, about 42.6% corn syrup solids and about 9.0% water.

The heated composition may also comprise between about 0.01% and about 5% of an emulsifier, about 0.01% and about 5% of a softener, between about 0.1 % and about 2% flavor and between about 0.01% and about 2% color. The flavor may be any chewing gum flavor. However, preferred flavors are those that can withstand temperatures at which the product is made and deposited, such as 95° C. The flavoring agents may comprise essential oils, synthetic flavors, or mixtures including but not limited to oils derived from plants and fruits such as citrus oils, fruit essences, peppermint oil, spearmint oil, clove oil, oil of wintergreen, anise and the like. Artificial flavoring components are also contemplated for use in the chewing gum products of the present invention. Typical artificial fruit flavors include fruit esters and fruit essential oils. In addition, fruit flavored products require the use of food acids to give the desired sensory attributes. Those skilled in the art will recognize that natural and artificial flavoring agents may be combined in any sensorially acceptable blend. All such flavors and flavor blends are contemplated by the present invention.

The emulsifier may be selected from the group consisting of lecithin, mono-and diglycerides, acetylated monoglycerides, and mixtures thereof. The softener may be selected from the group consisting of glycerin, sorbitol solution, propylene glycol, and mixtures thereof High-intensity sweeteners, such as salts of acesulfame; acesulfame K, alitame; sucralose; glycyrrhizin; saccharin and its salts; aspartame; N-substituted APM derivatives such as neotame; cyclamic acid and its salts; glycyruhizinate; dihydrochalcones, including neohesperidine; thaurmatin; monellin; aspartame-acesulfame salt; and the like, alone or in combination, may optionally be included.

In one method, the bulk sweetener syrup, gum base and powdered bulk sweetener are mixed together using high shear mixing in a tempered mixer. The bulk sweetener syrup, gum base and powdered bulk sweetener may each be heated to a temperature of at least 70° C. before being mixed together, and deposited at a temperature in the range of between about 70° C. and about 90° C. Preferably the composition contains less than 10% moisture and has a viscosity of less than 20,000 centipoise at a temperature of 90° C., preferably in the range of 10,000-17,000 centipoise at a temperature of 90° C., measured using a Haake VT 500 viscometer with a SVII sensor.

As mentioned above, the heated composition may be deposited in a first layer so as to only fill part of the depression, and a second heated composition different than the first deposited heated composition but also comprising a gum base may be deposited in the depression on top of the first layer. In that embodiment, the second heated composition may be exactly the same as the first heated composition, and differ only its color and/or flavor. This produces a multi-layer shaped chewing gum product. The first layer comprises a first cooled mixture of bulk sweetener syrup, powdered bulk sweetener and gum base previously heated and mixed into a first homogeneous composition. The second layer comprises a second cooled mixture of bulk sweetener syrup, powdered bulk sweetener and gum base previously heated and mixed into a second homogeneous composition different from the first composition. The first and second layers are adhered together forming the product. Of course this product has an intricate shape, and more than two layers can be formed in the product. In a multi-layer product, the layers may each be of a different color. Co-extrusion techniques can also be used to form unique designs using equipment known to those skilled in the art. In addition, the mold cavity may be partially filled, either before or after depositing the gum composition, with other confectionery material.

Typically multiple depressions are made in the bed of powdered material and each depression has the heated composition deposited into it. The depressions in one bed may all be of the same shape, or they may be of different shapes. The product may have a piece weight of between about 4 and about 12 grams, more preferably between about 7 and about 8 grams. If the product has a piece weight over about 14 grams, it may be preferable to reduce the gum base content in the heated composition so that the bolus left after the soluble components have been chewed from the product is of a more easily handled size.

It should be understood that other ways of shaping the products are within the scope of the present invention. The composition, while being particularly well suited for deposition forming, may otherwise be introduced into a cavity of a mold and take on the shape of the cavity when it cools or otherwise sets up. The product may be deposited into a mold tat will remain as part of the packaging for the product, such as a shaped blister, which is covered with a film or foil, and sold with the product inside. Alternatively, the product could be deposited, cooled and ejected from reusable molds, such as polycarbonate molds, flexible rubber molds, coated cast aluminum molds, etc.

The following examples are given to illustrate the invention, and are not to be considered as limiting.

### EXAMPLE 1

A high maltose corn syrup (Roquette Flolys C 4580) containing 80% corn syrup solids and 20% water was added to a cooker, along with sugar (sucrose) and water. The ratio was 42 parts sucrose, 46 parts corn syrup solids and 12 parts water. The solution was cooked to a temperature of 255° F. (124° C.) to obtain a sugar syrup with a solids content of about 91%. The sugar syrup was used in the formula below:

| Ingredients | % |
|---|---|
| Gum Base | 22.00 |
| Sugar Syrup | 55.00 |
| Sugar Powder | 19.96 |
| Lecithin | 0.20 |
| Glycerin | 2.00 |
| Flavor | 0.80 |
| Color | 0.04 |
| TOTAL | 100.00 |

The gum base was SHAPE gum base from CAFOSA GUM S.A. The gum base was melted at 203° F. (95° C.) and added to a high shear mixer (STEPHAN UMC 5 electronic 2011, using a standard mixing blade). The mixer was tempered at 203° F. (95° C.). The additional sugar powder was heated in an oven to 203° F. (95° C.). The gum base and hot syrup were added to the mixer, along with the lecithin (an emulsifier) and the color. These ingredients were mixed on 300-400 rpm for 1½ minutes. The powdered sugar and glycerin (as a softener) were added next and mixed at 300-400 rpm for 1 minute. Finally, the flavor was added and mixed at 300-400 rpm for an additional 1 minute. The batch size was about 2 kg. The material, at 203° F. (95° C.), was deposited into depressions in a starch mold. Each of the shapes of FIGS. 1-3, and others shapes, have been made using this composition. The products were made out of two different colored materials by depositing one layer first and then depositing a second material of a different color second. Most typically the piece size was between 5-7 grams.

The 55.00% sugar syrup in this example contributed 50.05% amorphous sugar sweetener, compared to 19.96% crystalline sugar sweetener contributed by the sugar powder. The ratio of crystalline sugar sweetener to amorphous sugar sweetener in the product was thus about 1:2.5. Since some of the amorphous sugars may have crystallized after being mixed in and cooled, this ratio may have gone down, but probably not below about 1:2

### EXAMPLE 2

In a second example, dextrose is used, and the sugar syrup is not heated before being combined with gum base. However, the mixture is heated to a temperature so that the dextrose melts. The product is very fluid for depositing. The dextrose then crystallizes as the product cools. The following ingredients are used in this example:

| Ingredients | % |
|---|---|
| Gum Base | 22.00 |
| Dextrose | 36.00 |
| Corn Syrup | 16.00 |
| Sugar Powder | 22.96 |
| Lecithin | 0.20 |
| Glycerin | 2.00 |
| Flavor | 0.80 |
| Color | 0.04 |
| TOTAL | 100.00 |

The corn syrup may be a high maltose corn syrup, such as Roquette Flolys C 4580, containing 80% corn syrup solids and 20% water, The gum base may be SHAPE gum base from CAFOSA GUM S.A. The gum base, corn syrup, lecithin and color are added to a gum mixer heated to about 104-113° F. (40-45° C.) and mixed about 4 minutes. The sugar powder is added and mixing continues for about 2 minutes. The glycerin is added and mixed for about 1 minute. The dextrose is added and mixed for about 2 minutes. The flavor is added and mixed for about 3 minutes. Thereafter the mixer is heated and mixing continues while the material in the mixer is heated to about 212-221° F. (100 to 105° C.). At this temperature the dextrose melts and the material is very fluid, and can be deposited into depressions in a starch mold having intricate shapes, or into other molds.

The amount of amorphous sugar sweetener in the product after it sets up is believed to be at least 10% of the composition. The 16.00% corn syrup in this example probably contributes about 12.8% amorphous sugar sweetener. The sugar powder contributes about 22.96% crystalline sugar sweetener. The dextrose, when it cools, crystallizes and contributes about 36.00% crystalline sugar sweetener. The ratio of crystalline sugar sweetener to amorphous sugar sweeter in the product is thus probably about 1:0.22. Since water was not removed from the corn syrup before it was mixed with the other ingredients, some of the sugars may have dissolved and ended up in an amorphous state when the mixture cooled.

### EXAMPLE 3

A sugarless chewing gum formulation is prepared from the following ingredients:

| Ingredients | % |
|---|---|
| Gum Base | 22.00 |
| Polyol Syrup | 55.00 |
| Maltitol Powder | 19.96 |
| Lecithin | 0.20 |
| Glycerin | 2.00 |
| Flavor | 0.80 |
| Color | 0.04 |
| TOTAL | 100.00 |

The polyol syrup is prepared by cooking Lycasin 80/55 HSH syrup from Roquette, which has a solids content of about 75%, with maltitol powder and additional water, the ratio of these ingredients is 42 parts maltitol powder, 46 parts HSH syrup and 12 parts water. The solution is cooked to a temperature sufficient to obtain a sugarless syrup with a solids content of about 91%. The syrup is used in the formulation above, following the process of Example 1, to make a sugarless product.

Using the present invention it is possible to make a product from only standard and basic ingredients of bubble gum, but which can be molded into intricate shapes, and maintain its shape during normal distribution, and still has acceptable texture and chew properties.

The typical products of the invention will have a texture and chew characteristics equivalent to those of a conventional bubble gum. For instance, the product will preferably have a soft initial bite and texture, similar to the Boomer product being sold by Joyco in April 2005, but will not be as soft as Hubba Bubba Max or Bubble Yum. The typical product can be chewed in the mouth for 2-3 hours and still be soft and chewable. The preferred product can be used to blow bubbles of 10 cm or greater.

While the invention has been described in conjunction with products that are completely made of the chewing gum composition, it should be understood that the products can also be a composite of the chewing gum composition and another material, such as a confection or a filling, like a jelly, used in a confection. For example, the deposited chewing gum can be given a center filling, such as a boiled hard candy co-deposited with the chewing gum composition. Further, the chewing gum itself may form, an internal portion of a composite product, such as a hard candy with a chewing gum center. Examples 4-9 provide sugar and sugar-free examples of co-deposited products, in which the deposited gum may be inside the other confectionery, surrounding the other confectionery, or in one or more layers with the other confectionery.

### EXAMPLE 4

### Co-Deposited Chewing Gum and Taffy

A co-deposited product is made with the fluid gum of Example 1 and a taffy-type confectionery made as follows:

| Ingredients | % |
|---|---|
| First Composition | |
| Sugar | 42.00 |
| Corn Syrup - 42 D.E. | 35.00 |
| Water | 10.00 |
| Sodium Citrate | 0.10 |
| Maltodextrin - 18 D.E. | 0.70 |
| Lecithin | 0.30 |
| Color | 0.05 |
| Gelatin Mixture | |
| Gelatin - 150 Bloom | 1.00 |
| Water | 2.00 |
| Powdered Citric Acid | 1.00 |
| Fondant Sugar | 1.10 |
| Vegetable Fat | 6.50 |
| Flavor | 0.25 |
| TOTAL | 100.00 |

First, the gelatin is dissolved in water. Next the first seven ingredients are cooked to 225° F. (107° C.) to form the first composition (cooked candy). The gelatin/water is added to the cooked candy and this mixture is whipped or pulled to incorporate air. Finally the powdered citric acid, fondant sugar, vegetable oil and flavor are added after the whipping step. The total product is then loaded into a feeding hopper for co-depositing hot with the fluid gum composition. For a softer taffy part of the product, the cook temperature of the cooked candy can be reduced. The moisture content of the taffy can be altered by altering the cook temperature to meet viscosity needs of any particular depositor that is used.

### EXAMPLE 5

### Co-Deposited Chewing Gum and Sugar-Free Taffy

A co-deposited sugar-free product is made with the fluid gum of Example 3 and a taffy-type confectionery made as follows:

| Ingredients | % |
|---|---|
| First Composition | |
| Maltitol Powder | 42.00 |
| Maltitol Syrup | 35.00 |
| Water | 10.00 |
| Sodium Citrate | 0.10 |
| Hydrogenated Maltodextrin | 0.70 |
| Lecithin | 0.30 |
| Color | 0.05 |
| Gelatin Mixture | |
| Gelatin- 150 Bloom | 1.00 |
| Water | 2.00 |
| Powdered Citric Acid | 1.00 |
| Fine Ground Maltitol Powder | 1.10 |
| Vegetable Fat | 6.50 |
| Flavor | 0.25 |
| TOTAL | 100.00 |

First the gelatin is dissolved in water. Next the first seven ingredients are cooked to 225° F. (107° C.) to form the first composition (cooked candy). The gelatin/water is added to the cooked candy and this mixture is whipped or pulled to incorporate air. Finally the powdered citric acid, fine ground maltitol powder, vegetable oil and flavor are added after the whipping step. The total product is then loaded into a feeding hopper for co-depositing hot with the fluid gum composition. For a softer taffy part of the product, the cook temperature of the cooked candy can be reduced. The moisture content of the taffy can be altered by altering the cook temperature to meet viscosity needs of any particular depositor that is used.

### EXAMPLE 6

### Co-Deposited Chewing Gum and Cooked/Hard Candy

A co-deposited cooked/hard candy product is made with the fluid gum of Example 1 and a cooked/hard candy confectionery made as follows:

| Ingredients | % |
|---|---|
| Sugar | 63.72 |
| Corn Syrup - 42 D.E. | 42.48 |
| Net Water loss | −6.50 |
| Color and Flavor | 0.30 |
| TOTAL | 100.00 |

The sugar, corn syrup and enough water to dissolve the sugar are combined. This water, and some of the water in the corn syrup, evaporates during cooking to produce the net water loss. The material is cooked to a temperature of 284-293° F. (140-145° C.). For a more glassy candy, try to prevent crystal growth by minimizing shear before loading into a feeder hopper for deposition with the fluid gum composition. For crystallized candy, increase the sugar content and reduce the amount of corn syrup. For a softer product, reduce the cook temperature.

### EXAMPLE 7

### Co-Deposited Chewing Gum and Sugar-Free Cooked/Hard Candy

A co-deposited sugar-free cooked/hard candy product is made with the fluid, deposited gum of Example 3 and a cooked/hard candy confectionery made as follows:

| Ingredients | % |
|---|---|
| Maltitol Powder | 63.72 |
| Maltitol Syrup | 42.48 |
| Net Water loss | −6.50 |
| Color and Flavor | 0.30 |
| TOTAL | 100.00 |

The maltitol powder, maltitol syrup and enough water to dissolve the maltitol powder are combined. This water, and some of the water in the maltitol syrup, evaporates during cooking to produce the net water loss. The material is cooked to a temperature of 320-329° F. (160-165° C.). For a more glassy candy, try to prevent crystal growth by minimizing shear before loading into a feeder hopper for deposition with the fluid gum composition. For crystallized candy, increase the maltitol powder percentage and reduce the maltitol syrup percentage. For a softer product, reduce the cook temperature.

### EXAMPLE 8

### Co-Deposited Chewing Gum and Caramel Candy

A co-deposited caramel candy product is made with the fluid gum of Example 1 and caramel candy confectionery made as follows:

| Ingredients | % |
|---|---|
| Butter or Margarine | 20.68 |
| Brown Sugar | 46.53 |
| Light Cream | 41.36 |
| Corn Syrup - 42 D.E. | 20.03 |
| Net Water loss | −29.10 |
| Color and Flavor | 0.50 |
| TOTAL | 100.00 |

Melt butter or margarine, add the rest of the ingredients, and cook to a temperature of about 255-260° F. (124-127° C.). The water loss comes from the butter or margarine, light cream and corn syrup. Transfer the product to the feeder hopper in the depositor. For a softer product, reduce the cook temperature.

### EXAMPLE 9

### Co-Deposited Chewing Gum and Sugar-Free Caramel Candy

A co-deposited sugar-free caramel candy product is made with the fluid gum of Example 3 and caramel candy confectionery made as follows:

| Ingredients | % |
|---|---|
| Butter or Margarine | 20.68 |
| Maltitol Powder | 46.53 |
| Light Cream* | 41.36 |
| Maltitol Syrup | 20.03 |
| Net Water loss | −29.10 |
| Color** and Flavor | 0.50 |
| TOTAL | 100.00 |

*Light Cream from a reduced lactose source is preferred.
**As polyols do not brown like sugars, caramel color will be added.

Melt butter or margarine, add the rest of the ingredients, and cook to a temperature of about 262-272° F. (128-133° C.). The water loss comes from the butter or margarine, light cream and corn syrup. Transfer the product to the feeder hopper in the depositor. For a softer product, reduce the cook temperature.

It should be understood that various changes and modifications to the embodiments presently described herein will be apparent to those skilled in the art. Such changes and modifications can be made without departing from the spirit and scope of the present invention and without diminishing its intended advantages. For example, the product can be made with multiple colors but not necessarily in layers. Two materials of different colors could be deposited simultaneously, or alternatively, and in swirls or other patterns. In some embodiments the composition does not include soluble protein. It is therefore intended that such changes and modifications be covered by the appended claims.

What is claimed is:

1. A method of making a deposited chewing gum product comprising:
a) mixing bulk sweetener syrup, gum base and powdered bulk sweetener together to form a fluid composition;
b) depositing the fluid composition into a depression in a bed of powder material at a temperature at which the fluid composition will fill into at least a portion of the shape of the depression;
c) allowing the fluid composition to set up to a consistency wherein the composition maintains the shape of the at least portion of the depression to form said deposited chewing gum product, the set up composition comprising between about 10% and about 60% crystalline bulk sweetener and between about 10% and about 70% amorphous bulk sweetener; and
d) separating the deposited chewing gum product from the powder material.

2. The method of claim 1 wherein the crystalline bulk sweetener comes at least in part from crystallization of some of the bulk sweetener in the bulk sweetener syrup.

3. The method of claim 1 wherein said gum base comprises a bubble gum base.

4. The method of claim 1 wherein the ratio of crystalline bulk sweetener to amorphous bulk sweetener in said set up composition is between about 1.14 and about 7:1 crystalline bulk sweetener: amorphous bulk sweetener.

5. The method of claim 1 wherein said set up composition comprises between about 15% and about 25% crystalline bulk sweetener and between about 45% and about 55% amorphous bulk sweetener.

6. The method of claim 1 wherein said set up composition comprises about 20% crystalline bulk sweetener and about 50% amorphous bulk sweetener.

7. The method of claim 1 wherein the bulk sweetener in said bulk sweetener syrup comprises a sugar selected from the group consisting of fructose, dextrose, corn syrup solids, sucrose, starch hydrolysates, maltodextrins and mixtures thereof.

8. The method of claim 1 wherein said powdered bulk sweetener is selected from the group consisting of sucrose, fructose, dextrose, starch hydrolysates and mixtures thereof.

9. The method of claim 1 wherein said bulk sweetener syrup comprises corn syrup and said powdered bulk sweetener comprises sucrose.

10. The method of claim 9 wherein said corn syrup has a powdered sucrose added to it and its moisture content reduced by cooking prior to being mixed with the gum base and an additional amount of powdered sucrose.

11. The method of claim 10 wherein said set up composition comprises between about 15% and about 25% crystalline sucrose, between about 19% and about 29% amorphous sucrose and between about 21% and about 31% corn syrup solids.

12. The method of claim 1 wherein said gum base comprises between about 12% and about 30% of the fluid composition.

13. The method of claim 10 wherein said powdered bulk sweetener comprises between about 10% and about 40% of the fluid composition.

14. The method of claim 10 wherein said bulk sweetener syrup comprises between about 30% and about 80% of the fluid composition.

15. The method of claim 1 wherein said fluid composition further comprises between about 0.01% and about 5% of an emulsifier.

16. The method of claim 1 wherein said fluid composition further comprises between about 0.01% and about 5% of a softener.

17. The method of claim 1 wherein said fluid composition further comprises between about 0.1% and about 2% flavor.

18. The method of claim 1 wherein said fluid composition further comprises between about 0.01% and about 2% color.

19. The method of claim 15 wherein said emulsifier is selected from the group consisting of lecithin, mono-and diglycerides, acetylated monoglycerides, and mixtures thereof.

20. The method of claim 16 wherein said softener is selected from the group consisting of glycerin; sorbitol solution, propylene glycol, and mixtures thereof.

21. The method of claim 1 wherein said bulk sweetener and gum base are heated to a temperature of at least 70° C. to form said fluid composition.

22. The method of claim 21 wherein said composition is allowed to cool to reach said consistency at which it maintains its shape.

23. The method of claim 1 wherein said gum base has a ring and ball softening point below 70° C.

24. The method of claim 1 wherein said gum base has a ring and ball softening point below 60° C.

25. The method of claim 1 wherein said gum base has a viscosity at 100° C. below 5,000 centipoise.

26. The method of claim 1 wherein said fluid composition is deposited at a temperature in the range of between about 65° C. and about 85° C.

27. The method of claim 1 wherein said fluid composition is deposited in a first layer so as to only fill part of said depression, and a second fluid composition different than the first deposited fluid composition but also comprising a gum base is deposited in the depression on top of said first layer.

28. The method of claim 27 wherein said second fluid composition differs from the first fluid composition in only its color.

29. The method of claim 27 wherein said second fluid composition differs from the first fluid composition in only its flavor.

30. The method of claim 27 wherein said second fluid composition differs from the first fluid composition in only its color and flavor.

31. The method of claim 1 wherein multiple depressions are made in said bed of powdered material and each depression has said fluid composition deposited into it.

32. The method of claim 1 wherein said deposited product comprise intricate shapes.

33. The method of claim 1 wherein said bulk sweetener syrup, gum base and powdered bulk sweetener are mixed together using high shear mixing.

34. The method of claim 1 wherein said bulk sweetener syrup, gum base and powdered bulk sweetener are mixed together in a tempered mixer.

35. The method of claim 1 wherein said bulk sweetener syrup, gum base and powdered bulk sweetener are each heated to a temperature of at least 70° C. before being mixed together.

36. The method of claim 1 wherein said product has a piece weight of between about 4 and about 12 grams.

37. The method of claim 1 wherein the fluid composition has a viscosity of less than 20,000 centipoise when it is deposited.

38. A method of making a shaped chewing gum product comprising:
a) mixing a first bulk sweetener syrup and a dry bulk sweetener together and cooking the mixture to adjust the moisture level in the mixture to form a second bulk sweetener syrup;
b) mixing said second bulk sweetener syrup, gum base and powdered bulk sweetener to-ether at a temperature of at least 70° C. to form a heated, fluid composition;
c) introducing the heated composition into a cavity having a desired shape so as to fill into at least a portion of the shape of the cavity;
d) cooling the heated composition to a temperature at which the composition maintains the shape of the at least portion of the cavity to form said shaped chewing gum product; and
e) separating the shaped chewing gum product from the cavity.

39. The method of claim 38 wherein the first bulk sweetener syrup and powdered bulk sweetener mixture is cooked to a temperature of over 120° C.

40. The method of claim 38 wherein the first bulk sweetener syrup and powdered bulk sweetener mixture is cooked to a moisture content of less than 10%.

41. The method of claim 38 wherein said gum base comprises between about 20% and about 40% of the heated composition.

42. The method of claim 38 wherein said gum base comprises between about 25% and about 35% of the heated composition.

43. The method of claim 38 wherein said gum base comprises between about 28% and about 30% of the heated composition.

44. A multi-layer shaped chewing gum product comprising:
a) a first layer comprising a first cooled mixture of bulk sweetener syrup, powdered bulk sweetener and gum base previously heated and mixed into a first homogeneous composition, the first homogeneous composition comprising between about 10% and about 60% crystalline bulk sweetener and between about 10% and about 70% amorphous bulk sweetener; and
b) at least a second layer comprising a second cooled mixture of bulk sweetener syrup, powdered bulk sweetener and gum base previously heated and mixed into a second homogeneous composition different from said first composition;
c) the first and second layers being adhered together forming the product and the product having an intricate shape.

45. The multi-layer shaped product of claim 44 wherein the first and second layers are each of a different color.

46. A chewing gum composition capable of being deposited to form chewing gum products having intricate shapes, the composition comprising:
a) about 12% to about 35% gum base;
b) about 10% to about 80% bulk sweetener syrup; and
c) about 10% to about 78% powdered bulk sweetener;
d) wherein the composition contains less than 10% moisture, has a ratio of crystalline bulk sweetener to amorphous bulk sweetener in said composition of between about 1:14 and about 7:1 crystalline bulk sweetener: amorphous bulk sweetener, and has a viscosity of less than 20 Pa-sec at a temperature of 90° C.

47. The composition of claim 46 wherein said composition comprises about 12% to about 30% gum base, about 30% to about 80% bulk sweetener syrup, and about 10% to about 40% powdered bulk sweetener, and wherein the bulk sweetener syrup comprises, on a dry basis, about 30% to about 70% sucrose and about 70% to about 30% corn syrup solids, and about 4% to about 15% water.

48. A shaped chewing gum product comprising a homogeneous composition comprising:
a) about 12% to about 30% gum base;
b) about 30% to about 80% of a bulk sweetener syrup comprising about 70% to about 95% of one or more bulk sweeteners and about 5% to about 20% water; and
c) about 10% to about 40% powdered bulk sweetener;
d) wherein the composition has a ratio of crystalline bulk sweetener to amorphous bulk swectcner in said composition of between about 1:14 and about 7:1 crystalline bulk sweetener: amorphous bulk sweetener, and wherein the product is formed into an intricate shape.

49. The product of claim 48 wherein the product maintains its shapc at a temperature of 35° C.

50. The product of claim 48 wherein product maintains its shape at a temperature of 40° C.

51. The product of claim 48 wherein product maintains its shape at a temperature of 45° C.

52. The product of claim 48 wherein the product has an intricate shape having one or more of the following attributes:
a) concavities,
b) compound curves that do not define product edges;
c) convex surfaces having acute angles;
d) convex surfaces having radii less than one third the dimension of the gross piece size that do not define product edges;
e) one or more curved regions having variable radii; and
f) product edges that are irregular or not substantially defined by simple geometric shapes.

53. The product of claim 48 wherein the product has a hardness, chewability and a softness equivalent to that of a conventional bubble gum.

54. The product of claim 48 wherein the product has a matrix that includes a bulk sweetener in crystalline form.

55. The method of claim I wherein said set up composition comprises between about 40% and about 70% amorphous bulk sweetener.

56. The method of claim 1 wherein the bulk sweetener in said bulk sweetener syrup comprises a sugar alcohol selected from the group consisting of sorbitol, maltitol, xylitol, erythritol, lactitol, hydrogenated starch hydrolysates, hydrogenated isomaltulose, mannitol, and mixtures thereof.

57. The method of claim 1 wherein said powdered bulk sweetener comprises a sugar alcohol selected from the group consisting of sorbitol, maltitol, xylitol, erythritol, lactitol hydrogenated starch hydrolysates, hydrogenated isomaltulose, mannitol, and mixtures thereof.

58. A co-deposited confection product comprising:
a) a chewing gum composition according to claim 46; and
b) a second confectionery other than a chewing gum composition.

59. The co-deposited confection product of claim 58 wherein the second confection comprises a hard candy.

60. The co-deposited confection product of claim 58 wherein the second confection comprises a chewy confection.

61. A co-deposited confection product comprising:
a) a chewing gum composition according to claim 46; and
b) a confectionery filling.
